(19) United States
(12) Patent Application Publication
(10) Pub. No.: US 2008/0087057 A1
(43) Pub. Date: Apr. 17, 2008

(54) Lock device

(76) Inventor: Chun-Te Yu, Fu-Hsing Hsiang (TW)

Correspondence Address: BACON & THOMAS, PLLC, 625 SLATERS LANE, FOURTH FLOOR, ALEXANDRIA, VA, 22314, US

(21) Appl. No.: 11/545,450

(22) Filed: Oct. 11, 2006

(51) Int. Cl. F16B 41/00

(52) U.S. Cl. 70/232

(57) ABSTRACT

A lock device includes a housing, a locking mechanism, and a shielding section located between the housing and the locking mechanism. The shielding section and at least part of the housing together define a restricting space. When the locking mechanism is set to a locked state relative to the housing, the shielding section is located at a position closing the restricting space, and when the locking mechanism is set to an unlocked state, at least part of the shielding section is displaceable relative to the housing to open the restricting space.

### FIELD OF THE INVENTION

The present invention relates to a lock device, and more particularly to a lock device that provides a restricting space for restricting a screw-type connection assembly therein. When the connection assembly is screwed to an article to be locked and the lock device is set to a locked state, the article could not be separated from the connection assembly by turning the article.

### BACKGROUND OF THE INVENTION

Generally, when a conventional lock device is used to lock a displayed electronic product, such as a liquid crystal display, a notebook computer, a printer, a digital walkman, or a mobile phone, the product must be provided with a hole or a ring as a fixing section, to which the lock device may be connected to thereby lock the product in place. In the event the electronic product does not include any structure for a lock device to connect thereto, the product is usually externally connected to an object that can be connected to the lock device. For instance, the product may be associated with a base having a fixing section, and the lock device is connected to the base to lock the product.

Some products, such as digital camera and telescope, are provided thereon with screw hole as a fixing section. However, the connection of the screw hole of the product to a screw bolt can only fix the product in place without protecting the product against theft. For the purpose of locking the product, the product must be first connected to a base provided with a fixing section for a lock. As can be understood by one having ordinary skill in the art, when the base is removed from the product, a mark would usually form on the product and could not be easily eliminated. Such mark would inevitably spoil the appearance and the value of the product, particular when the product is expensive and valuable. Moreover, the connection between the base and the product may be easily destroyed to separate the product from the base, resulting in a useless lock device.

It is therefore desirable to develop a lock device having a novel structure to overcome the problems in the conventional lock devices, so that when the lock device is screwed to an article and set to a locked state, the article could not be turned to separate from the lock device. Basically, unlike the conventional lock structures, the lock device according to the present invention does not form any mark or damage the article being locked, and can directly lock the article without the necessity of providing an additional base as a fixing section for locking to the article. The lock device of the present invention therefore has enhanced locking structure and is more reliable for use.

### SUMMARY OF THE INVENTION

A primary object of the present invention is to provide a lock device that has a restricting space, within which a connection assembly is restricted, such that when the connection assembly is connected to an article and the lock device is set to a locked state, the article could not be separated from the connection assembly by an external driving force.

Another object of the present invention is to provide a lock device that provides flexible locking manners by providing differently configured restricting spaces, so that the lock device may be used with different types of connection assembly to lock an article.

To achieve the above and other objects, the lock device according to the present invention includes a housing, a locking mechanism, and a shielding section located between the housing and the locking mechanism. The shielding section and at least part of the housing together define a restricting space. When the locking mechanism is set to a locked state relative to the housing, the shielding section is located at a position closing the restricting space, and when the locking mechanism is set to an unlocked state, the shielding section is displaceable relative to the housing to open the restricting space.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein

FIG. 1 is a perspective view of a lock device according to a first preferred embodiment of the present invention in a locked state;

FIG. 2 is a perspective view of the lock device of FIG. 1 in an unlocked state;

FIG. 3 is a sectioned side view of FIG. 1;

FIG. 4 is a sectioned side view FIG. 2 with a connection assembly removed from the lock device;

FIG. 5 is a perspective view of a lock device according to a second preferred embodiment of the present invention in a locked state;

FIG. 6 is a perspective view of the lock device of FIG. 5 in an unlocked state;

FIG. 7 is a sectioned side view of FIG. 5;

FIG. 8 is a sectioned side view of FIG. 6;

FIG. 9 is a perspective view showing a camera is connected to the lock device of FIGS. 5 and 6; and

FIG. 10 is a perspective view showing a lock device according to a third embodiment of the present invention.

### DETAILED DESCRIPTION OF THE PREFERRED EMBODIMENTS

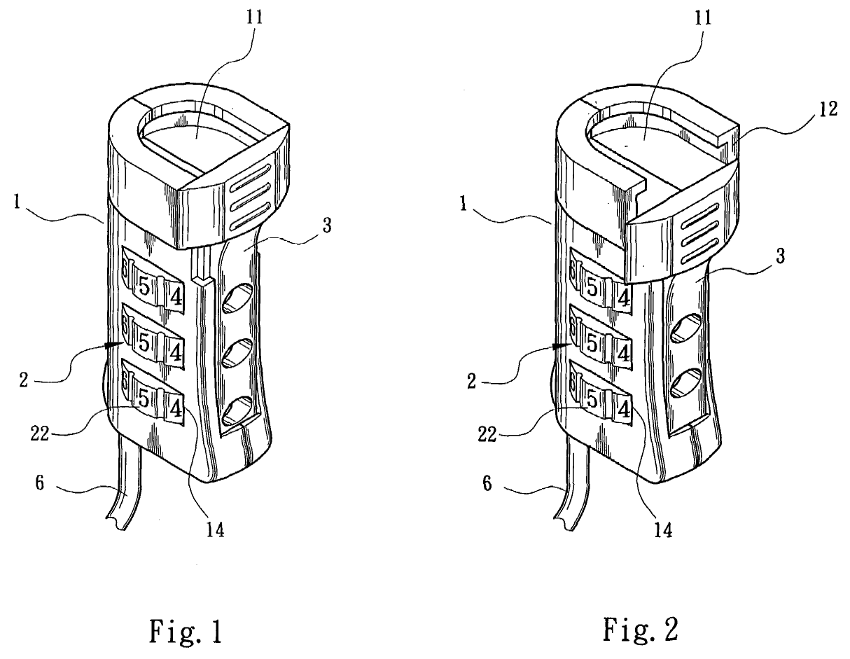

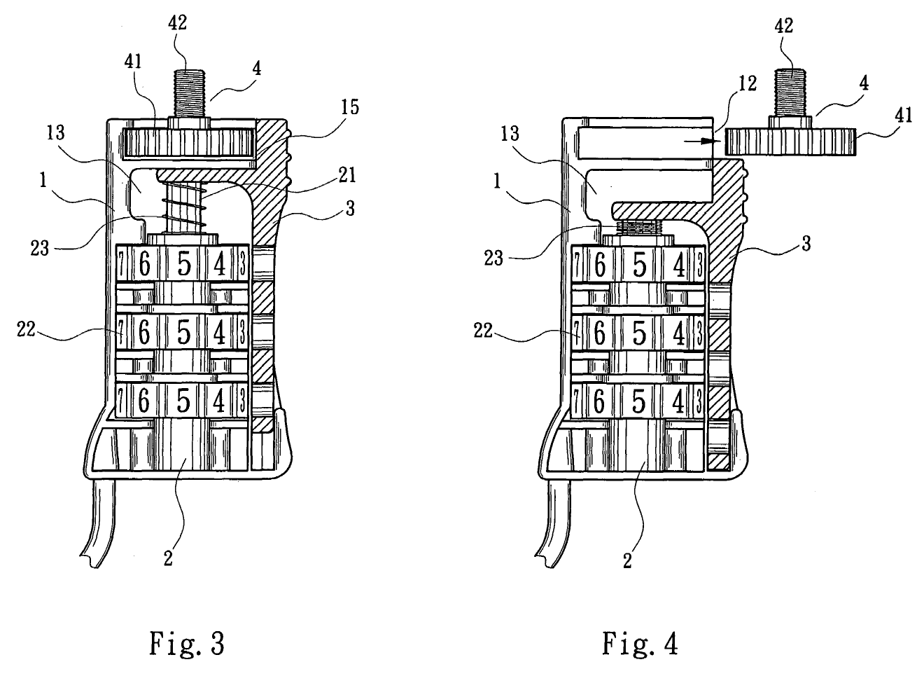

Please refer to FIGS. 1 and 2 that are perspective views showing the structure of a lock device according to a first preferred embodiment of the present invention in a locked and an unlocked state, respectively; and to FIG. 3 that is a sectioned side view of the lock device of FIG. 1. As shown, the lock device in the first preferred embodiment of the present invention includes a housing 1, a locking mechanism 2, and a shielding section 3 located between the housing 1 and the locking mechanism 2. The shielding section 3 and at least part of the housing 1 together define a restricting space 11. When the locking mechanism 2 is set to a locked state as shown in FIG. 1, the shielding section 3 is in a position to close the restricting space 11. Reversely, when the locking mechanism 2 is set to an unlocked state as shown in FIG. 2, at least part of the shielding section 3 is displaceable relative to the housing 1 to open the restricting space 11.

In the illustrated first preferred embodiment, the housing 1 defines an inner space 13 for receiving the locking mechanism 2 therein. The housing 1 is provided at a predetermined position with at least one operating zone 14. In the first preferred embodiment, the locking mechanism 2 is a core for a combination lock, and includes a control shaft 21 and a tumbler wheel assembly 22 for controlling movements of the control shaft 21. The control shaft 21 has an end linked with the shielding section 3, and a spring 23 is mounted around the control shaft 21 to push against the latter, so that the shielding section 3 is in a position of closing the restricting space 11 when the lock device is in the locked state. In another operable embodiment, the control shaft 21 has an end connected to the shielding section 3. When the tumbler wheel assembly 22 is in the unlocked state, the shielding section 3 may be manually driven by a user to displace; and when the lock device is in the locked state, the tumbler wheel assembly 22 retains the control shaft 21 in place and the shielding section 3 is restricted to the position of closing the restricting space 11.

Please refer to FIGS. 3 and 4 that are sectioned side views of FIGS. 1 and 2, respectively, showing the operation of the locking mechanism 2 inside the housing 1 when the lock device is separately set to the locked and the unlocked state. In the first preferred embodiment of the present invention, the lock device further includes a connection assembly 4, which includes a manipulating section 41 in the form of a rotating disk, and a connecting section 42 in the form of a screw bolt. The connecting section 42 is located at a center of the manipulating section 41, and the manipulating section 41 is mounted in the restricting space 11. The restricting space 11 has at least one openable area 12, via which a user may drive the manipulating section 41 to move the connecting section 42 at the same time, so that the connecting section 42 is engaged with or disengaged from an article to be locked. When the lock device is in the unlocked state, the connection assembly 4 may be removed from the restricting space 11 in a direction indicated by the arrow in FIG. 4.

In another operable embodiment, the housing 1 includes two detachably connected parts, and the locking mechanism 2 may be mounted in any one of the two parts of the housing 1. When the lock device is in the locked state, the two parts of the housing 1 are fixedly connected to each other to define the restricting space 11, so as to restrict and shield the manipulating section 41 of the connection assembly 4. And, when the lock device is in the unlocked state, the two parts of the housing 1 may be detached from each other, so that the connection assembly 4 is not restricted by the housing 1.

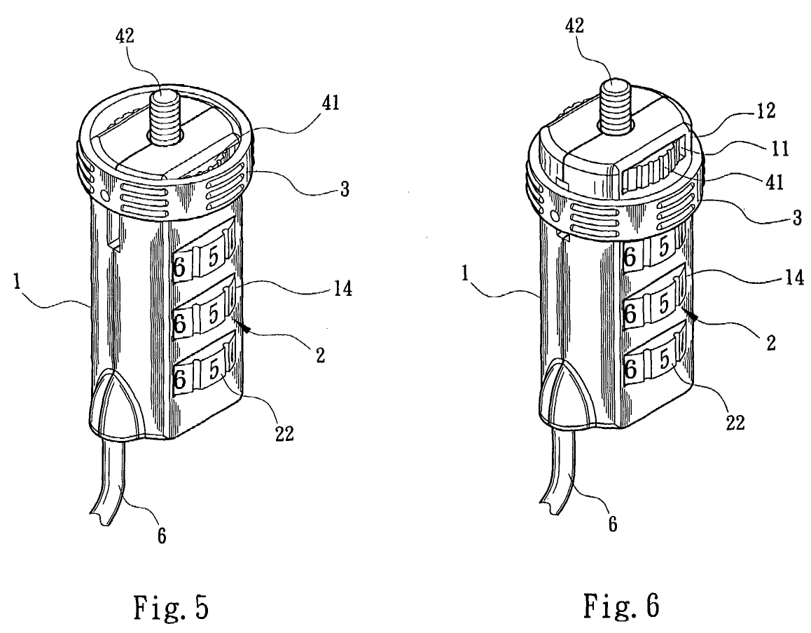

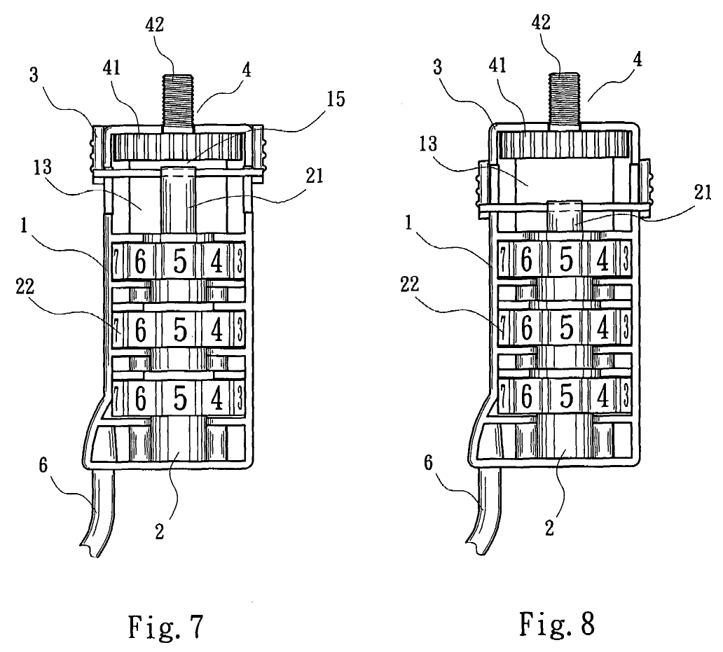

FIGS. 5 and 6 are perspective views of a lock device according to a second preferred embodiment of the present invention in a locked and an unlocked state, respectively, and FIGS. 7 and 8 are sectioned side views of FIGS. 5 and 6, respectively. In the illustrated second embodiment, the lock device includes a housing 1 having a restricting space 11, two opposite sides of which are provided with an openable area 12 each, and an operating zone 14; a locking mechanism 2 mounted in the housing 1 and including a control shaft 21 and a tumbler wheel assembly 22; a shielding section 3 movably mounted around the housing 1 and connected to the control shaft 21 of the locking mechanism 2; and a connection assembly 4 directly mounted in the restricting space 11, such that a manipulating section 41 of the connection assembly 4 may be driven by a user via the two openable areas 12 when the lock device is in an unlocked state. The connection assembly 4 also includes a connecting section 42 for connecting to an article. To lock the lock device to an article, a user may push the shielding section 3 upward to a position of shielding the openable areas 12 of the restricting space 11, while the control shaft 21 of the locking mechanism 2 connected to the shielding section 3 is simultaneously pulled upward, as shown in FIG. 7. At this point, the user may drive the locking mechanism 2 at the operating zone 14 on the housing 1, so that the locking mechanism 2 is set to the locked state to complete the locking operation.

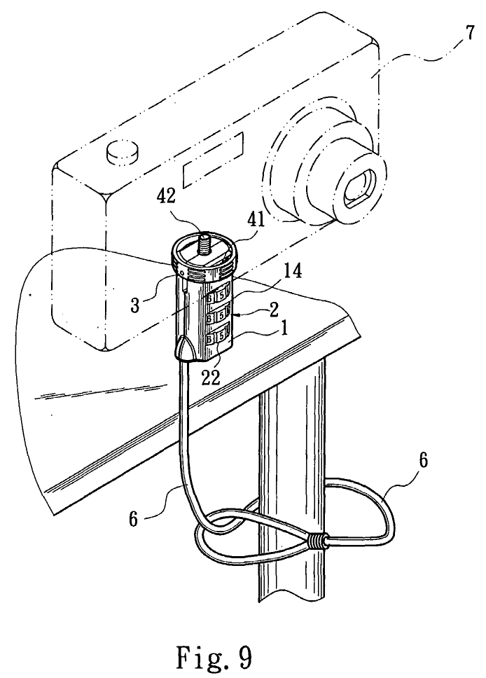

Please refer to FIG. 9 that shows the lock device according to the second preferred embodiment of the present invention is locked to a camera 7. The camera 7 is provided with an internally threaded screw hole adapted to engage with the connecting section 42. A cable 6 is used to bind the lock device of the present invention and accordingly the camera 7 to, for example, a table leg. As can be seen from FIG. 7, since there is a clearance 15 existed between the restricting space 11 and the connection assembly 4, it is impossible for someone to drive the lock device via the end having the camera 7 fixed thereto, or drive the camera 7 via the end having the lock device, in an attempt to disengage the connection assembly 4 from the camera 7. The clearance 15 would cause the connection assembly 4 to turn along with the camera 7 without becoming separated from the camera 7.

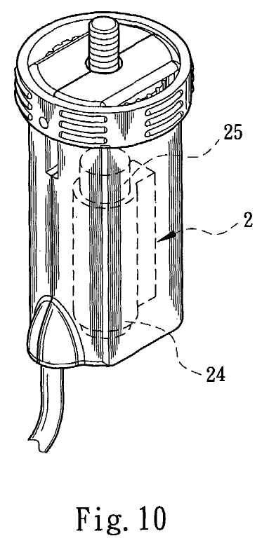

FIG. 10 shows a third embodiment of the present invention. In the third embodiment, the locking mechanism 2 is a core for a key lock. By using a key, the locking mechanism 2 may be locked or unlocked. The key lock core type locking mechanism 2 includes a sleeve 24 mounted in the housing 1, and a driving shaft 25 that can be driven by a key to turn in the sleeve 24, so as to set the locking mechanism 2 to a locked or an unlocked state.

A main purpose of the lock device of the present invention is to provide users with different types of connection assembly for connecting to or detaching from an article. The present invention overcomes the problem in the conventional lock devices of being not able to effectively lock a connection assembly in the form of a screw bolt to an article. In one embodiment of the present invention, the connection assembly is provided in the lock device. Since the lock device of the present invention may be implemented in many different manners, it may be manufactured according to actual need in different applications.

The present invention has been described with some preferred embodiments thereof and it is understood that many changes and modifications in the described embodiments can be carried out without departing from the scope and the spirit of the invention that is intended to be limited only by the appended claims.

What is claimed is:

1. A lock device comprising a housing, a locking mechanism, and a shielding section located between said housing and said locking mechanism; said shielding section and at least part of said housing together defining a restricting space; whereby when said locking mechanism is set to a locked state relative to said housing, said shielding section is located at a position closing said restricting space, and when said locking mechanism is set to an unlocked state, said shielding section is displaceable relative to said housing to open said restricting space.

2. The lock device as claimed in claim 1, wherein said locking mechanism is integrally formed in said housing.

3. The lock device as claimed in claim 1, wherein said locking mechanism is detachably mounted in said housing.

4. The lock device as claimed in claim 1, further comprising a connection assembly, said connecting assembly including a manipulating section and a connecting section, and said manipulating section being located in said restricting space; and wherein said restricting section has at least one openable area, via which said manipulating section may be manually driven to move said connecting section at the same time, such that said connecting section is connected to or detached from an article.

5. The lock device as claimed in claim 2, further comprising a connection assembly, said connecting assembly including a manipulating section and a connecting section, and said manipulating section being located in said restricting space; and wherein said restricting section has at least one openable area, via which said manipulating section may be manually driven to move said connecting section at the same time, such that said connecting section is connected to or detached from an article.

6. The lock device as claimed in claim 3, further comprising a connection assembly, said connecting assembly including a manipulating section and a connecting section, and said manipulating section being located in said restricting space; and wherein said restricting section has at least one openable area, via which said manipulating section may be manually driven to move said connecting section at the same time, such that said connecting section is connected to or detached from an article.

7. The lock device as claimed in claim 4, wherein said manipulating section is in the form of a rotating disc, and said rotating disc having a periphery being partially protruded from said restricting space via said at least one openable area.

8. The lock device as claimed in claim 5, wherein said manipulating section is in the form of a rotating disc, and said rotating disc having a periphery being partially protruded from said restricting space via said at least one openable area.

9. The lock device as claimed in claim 6, wherein said manipulating section is in the form of a rotating disc, and said rotating disc having a periphery being partially protruded from said restricting space via said at least one openable area.

10. The lock device as claimed in claim 4, wherein said connecting section is in the form of a screw bolt located at a center of said manipulating section for screwing to an article to be locked.

11. The lock device as claimed in claim 5, wherein said connecting section is in the form of a screw bolt located at a center of said manipulating section for screwing to an article to be locked.

12. The lock device as claimed in claim 6, wherein said connecting section is in the form of a screw bolt located at a center of said manipulating section for screwing to an article to be locked.

13. The lock device as claimed in claim 1, wherein said shielding section is displaceable to close or open an openable area provided on said restricting space.

14. The lock device as claimed in claim 1, wherein said housing defines an inner space for receiving said locking mechanism therein, and is provided on a predetermined position with at least one operating zone, via which said locking mechanism may be set to said locked or said unlocked state.

15. The lock device as claimed in claim 2, wherein said housing defines an inner space for receiving said locking mechanism therein, and is provided on a predetermined position with at least one operating zone, via which said locking mechanism may be set to said locked or said unlocked state.

16. The lock device as claimed in claim 3, wherein said housing defines an inner space for receiving said locking mechanism therein, and is provided on a predetermined position with at least one operating zone, via which said locking mechanism may be set to said locked or said unlocked state.

17. The lock device as claimed in claim 4, wherein said housing defines an inner space for receiving said locking mechanism therein, and is provided on a predetermined position with at least one operating zone, via which said locking mechanism may be set to said locked or said unlocked state.

18. The lock device as claimed in claim 5, wherein said housing defines an inner space for receiving said locking mechanism therein, and is provided on a predetermined position with at least one operating zone, via which said locking mechanism may be set to said locked or said unlocked state.

19. The lock device as claimed in claim 6, wherein said housing defines an inner space for receiving said locking mechanism therein, and is provided on a predetermined position with at least one operating zone, via which said locking mechanism may be set to said locked or said unlocked state.

20. The lock device as claimed in claim 7, wherein said housing defines an inner space for receiving said locking mechanism therein, and is provided on a predetermined position with at least one operating zone, via which said locking mechanism may be set to said locked or said unlocked state.

21. The lock device as claimed in claim 8, wherein said housing defines an inner space for receiving said locking mechanism therein, and is provided on a predetermined position with at least one operating zone, via which said locking mechanism may be set to said locked or said unlocked state.

22. The lock device as claimed in claim 9, wherein said housing defines an inner space for receiving said locking mechanism therein, and is provided on a predetermined position with at least one operating zone, via which said locking mechanism may be set to said locked or said unlocked state.

23. The lock device as claimed in claim 13, wherein said housing defines an inner space for receiving said locking mechanism therein, and is provided on a predetermined position with at least one operating zone, via which said locking mechanism may be set to said locked or said unlocked state.

24. The lock device as claimed in claim 1, wherein said locking mechanism is a core for a combination lock and includes a control shaft and a tumbler wheel assembly for controlling movements of said control shaft.

25. The lock device as claimed in claim 2, wherein said locking mechanism is a core for a combination lock and includes a control shaft and a tumbler wheel assembly for controlling movements of said control shaft.

26. The lock device as claimed in claim 3, wherein said locking mechanism is a core for a combination lock and includes a control shaft and a tumbler wheel assembly for controlling movements of said control shaft.

27. The lock device as claimed in claim 4, wherein said locking mechanism is a core for a combination lock and includes a control shaft and a tumbler wheel assembly for controlling movements of said control shaft.

28. The lock device as claimed in claim 5, wherein said locking mechanism is a core for a combination lock and includes a control shaft and a tumbler wheel assembly for controlling movements of said control shaft.

29. The lock device as claimed in claim 6, wherein said locking mechanism is a core for a combination lock and includes a control shaft and a tumbler wheel assembly for controlling movements of said control shaft.

30. The lock device as claimed in claim 24, wherein said control shaft has an end linked with said shielding section, and is pushed by a spring mounted around said control shaft.

31. The lock device as claimed in claim 25, wherein said control shaft has an end linked with said shielding section, and is pushed by a spring mounted around said control shaft.

32. The lock device as claimed in claim 26, wherein said control shaft has an end linked with said shielding section, and is pushed by a spring mounted around said control shaft.

33. The lock device as claimed in claim 27, wherein said control shaft has an end linked with said shielding section, and is pushed by a spring mounted around said control shaft.

34. The lock device as claimed in claim 28, wherein said control shaft has an end linked with said shielding section, and is pushed by a spring mounted around said control shaft.

35. The lock device as claimed in claim 29, wherein said control shaft has an end linked with said shielding section, and is pushed by a spring mounted around said control shaft.

36. The lock device as claimed in claim 1, wherein said locking mechanism includes a core for a key lock, and said key lock core is operable with a key to set said locking mechanism to said locked or said unlocked state.

37. The lock device as claimed in claim 2, wherein said locking mechanism includes a core for a key lock, and said key lock core is operable with a key to set said locking mechanism to said locked or said unlocked state.

38. The lock device as claimed in claim 3, wherein said locking mechanism includes a core for a key lock, and said key lock core is operable with a key to set said locking mechanism to said locked or said unlocked state.

39. The lock device as claimed in claim 4, wherein said locking mechanism includes a core for a key lock, and said key lock core is operable with a key to set said locking mechanism to said locked or said unlocked state.

40. The lock device as claimed in claim 5, wherein said locking mechanism includes a core for a key lock, and said key lock core is operable with a key to set said locking mechanism to said locked or said unlocked state.

41. The lock device as claimed in claim 6, wherein said locking mechanism includes a core for a key lock, and said key lock core is operable with a key to set said locking mechanism to said locked or said unlocked state.

42. The lock device as claimed in claim 36, wherein said key lock core includes a sleeve mounted in said housing, and a driving shaft that can be driven by a key to turn in said sleeve, so as to set said locking mechanism to said locked or said unlocked state.

43. The lock device as claimed in claim 37, wherein said key lock core includes a sleeve mounted in said housing, and a driving shaft that can be driven by a key to turn in said sleeve, so as to set said locking mechanism to said locked or said unlocked state.

44. The lock device as claimed in claim 38, wherein said key lock core includes a sleeve mounted in said housing, and a driving shaft that can be driven by a key to turn in said sleeve, so as to set said locking mechanism to said locked or said unlocked state.

45. The lock device as claimed in claim 39, wherein said key lock core includes a sleeve mounted in said housing, and a driving shaft that can be driven by a key to turn in said sleeve, so as to set said locking mechanism to said locked or said unlocked state.

46. The lock device as claimed in claim 40, wherein said key lock core includes a sleeve mounted in said housing, and a driving shaft that can be driven by a key to turn in said sleeve, so as to set said locking mechanism to said locked or said unlocked state.

47. The lock device as claimed in claim 41, wherein said key lock core includes a sleeve mounted in said housing, and a driving shaft that can be driven by a key to turn in said sleeve, so as to set said locking mechanism to said locked or said unlocked state.
